(19) United States
(12) Patent Application Publication
(10) Pub. No.: US 2012/0252665 A1
(43) Pub. Date: Oct. 4, 2012

(54) MULTIPHASE ALUMINA PARTICLE

(76) Inventors: Philip John Hughes, Northallerton (GB); Rachel Louise Smith, Bourne (GB)

(21) Appl. No.: 13/245,908

(22) Filed: Sep. 27, 2011

Related U.S. Application Data
(60) Provisional application No. 61/388,764, filed on Oct. 1, 2010.

(51) Int. Cl. B01J 21/06

(52) U.S. Cl. 502/439

(57) ABSTRACT

A particle having an alpha alumina crystalline phase, a non-alpha alumina crystalline phase and titania is disclosed. The particles are useful as catalyst carriers. A process for making the particles is also disclosed.

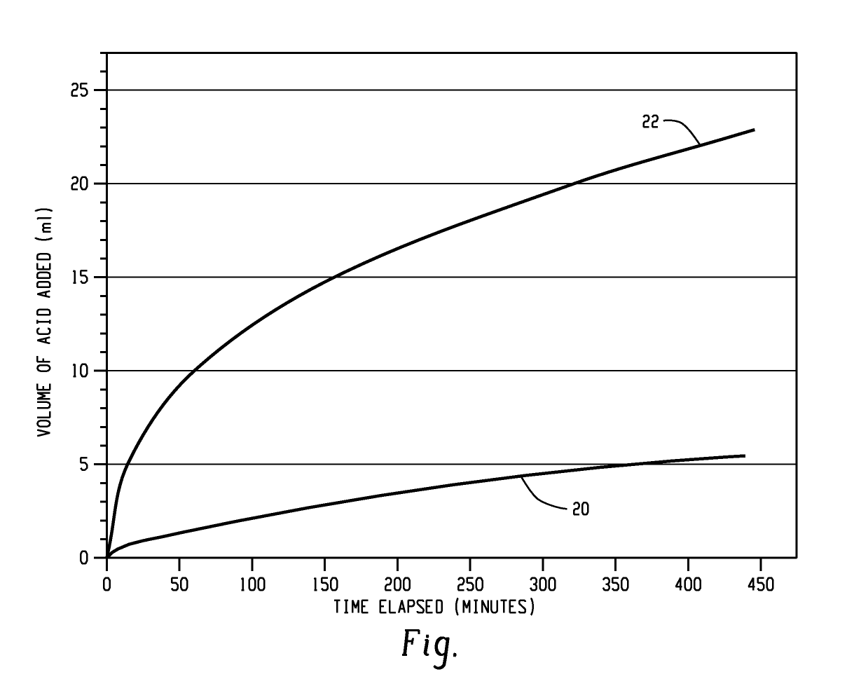

### CROSS-REFERENCE TO RELATED APPLICATION

This application claims the benefit of U.S. Provisional Application No. 61/388,764 filed Oct. 1, 2010.

### BACKGROUND OF THE INVENTION

This invention generally relates to ceramic particles for use as catalyst supports. More particularly, this invention is concerned with catalyst supports for use in chemical reactors which expose the supports to high temperatures and acidic environments.

Catalyst supports useful in fluidized bed applications are disclosed in U.S. Pat. No. 7,351,679 and US 2007/0161714.

### SUMMARY

In one embodiment, the present invention is a particle comprising at least 80 weight percent alumina and at least 5 weight percent titania. The alumina has at least two crystalline phases including a non-alpha alumina crystalline phase and an alpha alumina crystalline phase.

Another embodiment of the present invention relates to a process for manufacturing a ceramic particle that has two distinct crystalline phases. The process may include the following steps. Providing a particle precursor comprising at least 90 weight percent non-alpha alumina. Coating the particle precursor with a phase change promoter thereby forming a coated particle precursor. Heating the coated particle precursor to a phase conversion temperature which is both (1) above the minimum temperature needed to convert a first portion of the coated particle precursors to alpha alumina and (2) below the minimum temperature needed to convert a second portion of the coated particle precursors to alpha alumina thereby creating a particle comprising an alpha alumina crystalline phase and a non-alpha alumina crystalline phase.

### BRIEF DESCRIPTION OF THE DRAWING

The FIGURE is a graph of the acid resistance of carriers calcined at different temperatures.

### DETAILED DESCRIPTION

The use of catalysts in chemical reactors to improve the efficiency of a reaction between two or more reactants is a well established practice in numerous chemical processes. The catalysts may include a catalytically active material, deposited onto ceramic particles which are commonly referred to as “carriers” or “supports”. The carrier serves as a substrate for the catalytically active material. The catalytically active material usually resides on or near the surface of the carrier and facilitates a reaction between the reactants. Numerous patents and journal articles have documented the influence of the carrier on the performance of the catalyst. To perform properly in some processes, a carrier may need to be physically and chemically stable when exposed to (a) extreme temperatures, such as 200° C. or higher and (b) extremely acidic or basic conditions. The selection of raw materials used to make the carrier, the processes used to manufacture the carrier and the conditions in which the carriers will be used must all be coordinated to produce a stable and efficient catalyst carrier.

In the hydrocarbon conversion industry, catalysts that incorporate a catalytically active material deposited onto a plurality of ceramic particles, known as carriers, may be used in slurry bed applications. Ceramic particles used as carriers generally consist of uniphase ceramic materials such as aluminas, titanias, zirconias and silicas. As used herein, uniphase is defined to mean the carrier's crystalline phase is a single crystalline phase. It is understood that the porosity, surface area and attrition are all physical characteristics that can directly and significantly impact the performance of the catalyst. For example, in some industrial applications, the selectivity of the catalyst may benefit from alumina carriers possessing a delta phase crystalline structure which have greater porosity and surface area than a catalyst with alumina carriers possessing an alpha phase crystalline structure. However, the alpha phase alumina carriers may offer greater acid resistance and lower attrition than the delta phase alumina carriers. For many to conventional carriers that are uniphase the catalyst has either good selectivity and poor acid resistance or poor selectivity and good acid resistance. Uniphase carriers, which may also be described herein as carriers having a single or homogeneous crystalline phase, may not be able to offer both the acid resistance available with alpha phase carriers and the selectivity available with delta phase carriers. The inventors of the invention described herein recognized the problem created by using a uniphase carrier and have discovered a way to provide a carrier that simultaneously provides good acid resistance, good selectivity and low attrition. The carrier, which may be generally described as a ceramic particle, may be used in a wide variety of commercial processes that include a slurry of reactants and catalysts simultaneously moving and flowing past one another within a reactor.

Within the field of slurry bed applications, one body of technical expertise known as Gas-to-Liquid (GTL) technology is used to convert physically isolated deposits of natural gas (methane) into a range of liquid hydrocarbon products. Within the GTL process, a slurry phase Fischer-Tropsch synthesis (FTS) reaction is used to convert carbon monoxide and hydrogen generated from the natural gas into water and hydrocarbons, which can be economically transported using conventional transportation infrastructures. During the FTS reaction the catalyst, which is typically suspended in a molten hydrocarbon wax, may be exposed to high temperature hydrothermal conditions and, because some of the products generated during the reaction may be organic acids, the pH of the slurry in which the catalyst is entrained is generally acidic. The acidic, high temperature hydrothermal environment may degrade the performance of the catalyst by rehydrating and dissolving the carrier. This may also cause problems in efficient catalyst separation and in extreme cases may prematurely shut down the reactor. Consequently, to be successful in an FTS process, a catalyst carrier is desirably acid resistant and stable in high temperature hydrothermal conditions.

One embodiment of a ceramic particle of this invention that provides the desired acid resistance and stability in a high temperature hydrothermal to environment may have two crystalline alumina phases that include a non-alpha alumina crystalline phase and an alpha alumina crystalline phase. The non-alpha alumina phase may be designated herein as the primary crystalline phase and the alpha alumina phase may be designated herein as the secondary crystalline phase. The secondary phase may be a coating of alpha alumina formed in situ on the non-alpha alumina primary phase. The primary crystalline phase may be a transitional phase alumina such as chi, kappa, gamma, delta, eta or theta, and may be free of titania. In contrast, the alpha alumina may include titania and the crystalline phase of the titania may be rutile. Furthermore, the crystalline phase of titania may be essentially rutile or consist solely of rutile. The two phases of alumina are considered to exist in the ceramic particle if X-ray diffraction analysis confirms the existence of an alpha alumina crystalline phase and a non-alpha alumina crystalline phase. The X-ray diffraction analysis may be performed on a Seimans D5000 diffractometer with CuKₐ X-rays of wavelength 1.5406 \acute{Å}, an X-ray current of 30 mA, a voltage of 40 kV, a scan rate of 1 s/step and a 0.02° step change.

The ceramic carrier particles are prepared from a carrier precursor. Processes used to produce a carrier precursor include spray drying and extrusion. In a conventional spray drying process a slurry that includes a solid material suspended in a liquid phase is sprayed into a heated chamber. The spraying action generates droplets which fall through the heated chamber. The heat drives off the liquid thereby leaving a plurality of agglomerated carrier precursor particles

A preferred embodiment of the carrier of this invention may be made by coating and then calcining a non-alpha alumina particle precursor powder which has one or more non-alpha alumina transitional crystalline phases and may have an amorphous phase. The coating process may be an impregnation process. The powder may be at least 90 weight percent, 95 weight percent or even 99 weight percent non-alpha alumina. A plurality of powdered precursors may be used.

The particle precursor powder is coated with a phase change promoter which, by definition, reduces the temperature needed to convert the transitional alumina or amorphous alumina to alpha alumina. The portion of the precursor powder in direct contact with the phase change promoter may be referred to herein as the first portion of the coated particle precursor. The portion of the precursor powder that is not in direct contact with the phase change promoter may be referred to herein as the second portion of the coated particle precursor. The temperature at which a carrier's transitional alumina is converted to alpha alumina is defined as the carrier's phase conversion temperature. Suitable phase change promoters may include the following alkoxide complexes which are commercially available as liquids: tetra-isopropyl titanate Ti(OCH(CH₃)₂)₄, abbreviated TIPT; tetra-n-butyl titanate Ti(O(CH₂)₃CH₃)₄, abbreviated TNBT; Ti(acac)₂(1,3-propanediol) and Ti(acac)₂((CH₃)₂CHO)(CH₃CH₂O). While including titanium in the phase change promoter may not be required, the compounds described above include titanium and provide the desired reduction in the phase conversion temperature when evaluated in the examples described below.

A technique that may be used to coat the precursor powder's surface with a phase change promoter is known as incipient wetness impregnation. This technique includes mixing a liquid phase change promoter, such as one of the alkoxide complexes described above, with an appropriate quantity of precursor powder. The phase change promoter may be diluted with a diluent such as isopropanol. The quantities of liquid phase change promoter and precursor powder are selected such that the liquid completely fills the pores in the precursors but does not provide an excess of liquid thereby leaving the appearance of a dry powder after the precursors and liquid are mixed with one another. The quantity of liquid needed to fill the pores in the precursor may be determined empirically or may be calculated using nitrogen physisorption. The impregnated powder may be dried by increasing the temperature of the powder at a rate of 0.5° C./min to a final temperature of 60° C. followed by a three hour hold. The powder may then be calcined by increasing the temperature at a rate of 2° C./min to the required calcining temperature and then held for seven hours. If desired, two or more impregnation steps may be used to increase the quantity of phase change promoter deposited in the pores of the precursor. Suitable loadings of titania are 10 weight percent, 15 weight percent and 20 weight percent based on the weight of the ceramic particle. Intermediate loadings such as 12, 16 or 18 weight percent titania are also feasible.

### Examples

To illustrate the advantages of an embodiment of a ceramic particle of this invention the following lots of ceramic particles were manufactured and the existence of a primary crystalline phase of non-alpha alumina, a secondary crystalline phase of alpha alumina and a crystalline phase of the titania were determined. In addition, the attrition and acid resistance of selected lots were measured to illustrate the improved resistance to acidic degradation offered by a ceramic particle of this invention.

One embodiment of this invention was prepared as follows and is designated herein as Lot A. The coating process used to apply a coating of the phase change promoter to the surface of the particle precursor was an incipient wetness impregnation technique. The process included providing a quantity of γ-Al₂O₃ powder known as SCCa 5/150 which was obtained from Sasol Germany GmbH, Anckelmannsplatz 1, D-20537 Hamburg, Germany. The particles of the γ-Al₂O₃ powder are considered herein to be carrier precursors which may also be described as particle precursors. The carrier precursors had a uniphase gamma crystalline phase which, as defined herein inherently limits the powder's crystalline phase to at least 90 weight percent non-alpha alumina. The carrier precursors were then mixed with a sufficient amount of Tetra-isopropyl titanate (TIPT), which was obtained from Vertec business of Johnson Matthey Catalysts, based in Billingham, Cleveland, U.K. The TIPT was diluted with isopropanol. The quantity of diluted TIPT was selected to fill the precursors' pores without leaving an excess of liquid thereby producing a dry powder. The carrier precursors were then exposed to a flow of nitrogen gas for one hour in a calcination oven. The temperature in the oven was then increased at a rate of 0.5° C./min to a temperature of 60° C. The coated powder was dried by heating at 60° C. for three hours. The dried, coated precursors were calcined by increasing the temperature of the oven at a rate of 2° C./min to 950° C. and then holding at that temperature for seven hours thereby generating ceramic carrier particles. X-ray diffraction analysis and pore size measurements of the resulting particles in Lot A confirmed the existence of an alpha crystalline phase, a delta crystalline phase and the crystalline phase of the titania was rutile.

A second lot of ceramic carrier particles was prepared using the SCCa 5/150 γ-Al₂O₃ powder obtained from Sasol. The second lot, designated herein as Lot B, was prepared using the same process used to make the ceramic carrier particles in Lot A except that the precursor was calcined to a temperature of 750° C. instead of 950° C. X-ray diffraction analysis and pore size measurements of the resulting particles in Lot B confirmed the existence of a delta crystalline phase, the lack of an alpha crystalline phase and the crystalline phase of the titania was anatase. This data supports the conclusion that the phase conversion temperature of the titania coated layer of alumina was between 750° C. and 950° C.

A third lot of ceramic carrier particles, designated herein as Lot C, was prepared as follows. A quantity of SCCa 5/150 γ-Al₂O₃ powder was not coated with the TIPT and divided into three equal portions designated portion 1, portion 2 and portion 3. Portion 1 was calcined to 950° C. using the thermal profile described above. X-ray diffraction analysis of the resulting particles in Lot C's portion 1 confirmed the existence of delta and theta crystalline phases. No alpha alumina was detected. Portion 2 was then calcined to 1000° C. The X-ray diffraction analysis of the resulting particles in portion 2 also confirmed the lack of an alpha crystalline phase. Portion 3 was calcined to 1050° C. X-ray diffraction analysis indicated the presence of a small amount of alpha alumina. The X-ray diffraction analyses from Lot C's first, second and three portions, in combination with the data from Lot A, supports the following conclusions. First, the phase conversion temperature of the noncoated ceramic particles (i.e. Lot C) was much greater than 950° C. Second, the rutile titania functioned as a phase change promoter because the presence of rutile titania in Lot A effectively lowered the precursor's phase conversion temperature from well above 950° C. to less than 950° C.

A fourth lot of ceramic carrier particles was prepared using the SCCa 5/150 γ-Al₂O₃ powder obtained from Sasol. The fourth lot, designated herein as Lot D, was prepared using the same process used to make the ceramic carrier particles in Lot A except that the precursor was calcined to a maximum temperature of 550° C. instead of 950° C. Due to the lower calcination temperature, the ceramic carrier particles in Lot D had only transitional alumina crystalline phases.

The attrition of ceramic particles from lots A and D were then determined by air-jet attrition. The method used was ASTM D5757-00 and particles less than 20 μm were defined as fines. Approximately 50 grams of ceramic particles were required with particle sizes between 10 and 180 μm. The Air Jet Index, which is a unitless value equal to the percent attrition loss at five hours, was calculated for Lots A and D. Shown below in Table 1 are the results of the attrition tests. A low percentage attrition is better than a high percentage attrition. The data supports the conclusion that the particles in Lot A, which had both alpha and delta crystalline phases, had approximately twenty percent less attrition than the particles in Lot D which had only transitional alumina phases. The existence of the alpha alumina is believed to have resulted in less attrition.

TABLE 1

| | Percent Attrition |
|---|---|
| | After 5 hours |
| Lot A | 8.7 |
| Lot D | 11.1 |

With regard to acid resistance, the ceramic particles' resistance to dissolution by acid may be important because the particles used as carriers for catalyst in an FTS reaction may be exposed to a low pH environment as the reaction proceeds within the reactor. The low pH can cause the alumina support to rehydrate to boehmite (AlOOH) and subsequently dissolve. As the support is hydrated the H⁺ ions are removed from solution so the pH increases. The procedure described below quantifies the dissolution by tracking the amount of to acid that must be added to the solution to offset the increase in the pH caused by the dissolution and thereby maintain the pH at a constant value. To quantify a particle's resistance to dissolution by acid, the acid resistance of the lots was determined as follows. A 25 gram quantity of a particular lot of ceramic particles was slurried in 250 grams of water and stirred continuously throughout the procedure. A Titroline alpha plus TA50 auto-titrator was used to maintain the pH below 2 by dosing in 10 percent nitric acid as required. The amount of acid added was recorded at various time intervals and a plot of acid added against time was created to provide an objective measure of the particles resistance to dissolution by the acid. With reference to the FIGURE, line 20 represents the amount of acid needed to maintain the pH of carriers from Lot A which had an alpha alumina crystalline structure, a delta alumina crystalline structure and rutile titania. Line 22 represents the amount of acid needed to maintain the pH of carriers from Lot B which had only non-alpha alumina crystalline phases and the titania's crystalline phase was anatase. In this evaluation of resistance to acidic dissolution, the lower level of acid added over a fixed period of time for the carriers from Lot A (line 20) indicates that the carriers from Lot A were more resistant to acid dissolution than the carriers from Lot B (line 22) throughout the entire elapsed time of the evaluation.

The above description is considered that of particular embodiments only. Modifications of the invention will occur to those skilled in the art and to those who make or use the invention. Therefore, it is understood that the embodiments described above are merely for illustrative purposes and are not intended to limit the scope of the invention which is defined by the following claims.

What is claimed is:

1. A particle, comprising:
a. at least 80 weight percent alumina, said alumina comprising at least two crystalline phases comprising a non-alpha alumina crystalline phase and an alpha alumina crystalline phase; and
b. at least 5 weight percent titania.

2. The particle of claim 1 wherein said alumina's two crystalline phases comprise a primary crystalline phase and a secondary crystalline phase and said primary crystalline phase is said non-alpha alumina crystalline phase and said secondary crystalline phase is said alpha alumina crystalline phase.

3. The particle of claim 2 wherein said non-alpha alumina's crystalline phase is delta.

4. The particle of claim 1 wherein said titania comprises a rutile crystalline phase.

5. The particle of claim 1 wherein said titania comprises a primary crystalline phase and said primary crystalline phase consists essentially of rutile.

6. The particle of claim 5 wherein said titania's primary crystalline phase consists of rutile.

7. The particle of claim 1 wherein said particle comprises at least 10 weight percent titania.

8. The particle of claim 1 wherein said particle comprises at least 15 weight percent titania.

9. The particle of claim 1 wherein said particle comprises no more than 20 weight percent titania.

10. A process, for manufacturing a particle, comprising the steps of:
a. providing a particle precursor comprising at least 90 weight percent non-alpha alumina;
b. coating said particle precursor with a phase change promoter thereby forming a coated particle precursor; and
c. heating said coated particle precursor to a phase conversion temperature which is both (1) above the minimum temperature needed to convert a first portion of the coated particle precursor to alpha alumina and (2) below the minimum temperature needed to convert a second portion of the coated particle precursor to alpha alumina thereby creating a particle comprising an alpha alumina crystalline phase and a non-alpha alumina crystalline phase.

11. The process of claim 10 wherein said coating step (b) comprises impregnating said particle precursor with a phase change promoter.

12. The process of claim 10 wherein said particle precursor in step (a) has an amorphous structure.

13. The process of claim 10 wherein said phase change promoter comprises titanium.

14. The process of claim 13 wherein said titania comprises a rutile crystalline phase.

15. The process of claim 10 wherein said non-alpha alumina crystalline phase is a transitional crystalline phase.

16. The process of claim 15 wherein said transitional phase is a crystalline phase selected from the group consisting of chi, kappa, gamma, delta, eta and theta.

17. The process of claim 16 wherein said transitional phase is delta.

18. The process of claim 10 wherein said coating step comprises at least a first coating and at least a second coating.

19. The process of claim 10 wherein the particle precursor in step (a) comprises at least 95 weight percent non-alpha alumina.

20. The process of claim 10 wherein the particle precursor in step (a) comprises at least 99 weight percent non-alpha alumina.

21. The process of claim 10 wherein said phase conversion temperature equals or exceeds 750° C.

22. The process of claim 10 wherein said phase conversion temperature does not exceed 950° C.
